(19) United States
(12) Patent Application Publication
(10) Pub. No.: US 2018/0174075 A1
(43) Pub. Date: Jun. 21, 2018

(54) GRAPHICAL USER INTERFACE TO PROVIDE TRIP INFORMATION

(71) Applicant: GOOGLE INC., Mountain View, CA (US)

(72) Inventors: Rani S. Manoharan, Cambridge, MA (US); Frederick Peter Brewin, San Francisco, CA (US)

(21) Appl. No.: 15/382,580

(22) Filed: Dec. 16, 2016

(51) Int. Cl. G06Q 10/02; G06Q 10/10; G06F 3/0482

(52) U.S. Cl. CPC G06Q 10/02; G06T 11/206; G06F 3/0482; G06Q 10/1095

(57) ABSTRACT

Travel preferences are received from a user for a trip including a starting location, starting travel date, destination and arrival date. At least one month is presented in a calendar via a graphical user interface, including a month associated with the starting travel date. For one or more days from the starting travel date, a value of a feature is determined that is associated with originating travel on a respective day. A lowest value of the feature is determined of a ticket to travel on a trip starting on the respective day that lasts a projected number of days equal to a proposed trip length plus or minus a predetermined number of days. The lowest value of the feature for each day is presented in the calendar and in a graph that includes axes representing value of the feature and days.

### TECHNICAL FIELD

The present disclosure relates to a graphical user interface that provides trip information for users. More specifically, a graphical user interface displays a calendar comprising feature data for a trip and a graph displaying the feature data.

### BACKGROUND

This specification relates to information presentation via graphical user interfaces.

When making travel plans, a user can select dates and locations associated with travel, e.g., including airline travel, hotel accommodations, car rental and the like. Information associated with the user's selections can be presented. Conventional systems can provide, for example, a range of features associated directly with the user's selections so that the user can view features corresponding to exactly the inputs that the user entered.

### SUMMARY

Rendering graphical user interfaces to display values of features for trips includes displaying a projected number of days based on indications of user travel preferences for the trips. One or more computing devices receives an indication of travel preferences for a trip, including a starting location, a starting travel date, a destination and a return date. A length of time from the starting travel date to the return date constitutes a proposed trip length. The one or more computing devices provides instructions to the user computing device causing the user computing device to render a graphical user interface, the graphical user interface comprising a calendar, at least one month including at least a month associated with the starting travel date. The one or more computing devices determines, for one or more days from the starting travel date, a value of a feature associated with a cost of originating travel on a respective day for the trip, including determining a lowest value of the feature of a ticket to travel on a trip starting on the respective day that lasts a projected number of days. The projected number of days is the proposed trip length plus or minus a predetermined number of days. The one or more computing deices provide instructions to the user computing device causing the user computing device to render, via the graphical user interface, an indication, in the calendar, of the lowest value of the feature for each respective day of the one or more days and a graph comprising an indication of the value of the feature for each respective day, wherein the graph comprises one axis that represents value of the feature and one axis that represents days.

### Overview

In general, one innovative aspect of the subject matter described in this specification can be implemented in methods that include a computer-implemented method for presenting feature information. The method includes receiving an indication of travel preferences of a user for a trip including a starting location, a starting travel date, a destination and an arrival date, wherein a length of time from the starting travel date to the arrival date constitutes a proposed trip length. The method further includes presenting, in a calendar, at least two months including at least a month associated with the starting travel date. The method further includes determining, by one or more processors, for one or more days from the starting travel date, a feature associated with a value of originating travel on a respective day for the trip, including determining a lowest value for the feature of a ticket to travel on a trip starting on the respective day that lasts a projected number of days, wherein the projected number of days is the proposed trip length plus or minus a predetermined delta number of days. The method further includes presenting, in a first user interface, the lowest value of the feature for each day of the one or more days in the calendar. The method further includes presenting, in the first user interface, the lowest value for the feature for each day in a graph, wherein the graph includes one axis that represents price and one axis that represents days.

These and other implementations can each optionally include one or more of the following features. The trip can include air travel and the value of the feature is a value associated with the air travel. The predetermined delta number of days can be two. Presenting the calendar can include presenting two months including a month of and a month following the arrival date. The method can further include receiving a selection of a starting travel date in association with the presentation of the first user interface, updating feature data for the calendar including determining a lowest value of the feature to complete a trip that starts on the selected starting travel date and ends on a respective day, and updating the calendar including presenting updated price data for each respective day of the one or more days. The method can further include updating the graph to reflect the updated feature data. The method can further include receiving a selection of an arrival travel date in association with the presentation of the first user interface without receiving a selection of the starting date, updating price data for the calendar including determining a lowest value of the feature to complete a trip that ends on the selected arrival date, and updating the calendar including presenting updated feature data for each respective day of the one or more days. The method can further include receiving a selection of an arrival date, presenting a selection to the user of a lowest value of the feature for the selected starting date and selected arrival date including presenting the user with a filter to receive preference selections for filtering trips based on one or more trip parameters. The trip parameters can be selected from the group comprising number of stops, length of trip, type of airplane, on-time performance, configuration of airplane, service provider or rating of airplane or service provider. The method can further include surfacing to the user a lower cost alternative that approximates the user's selection of the travel preferences as compared to a value of the feature associated with a trip that is based on the user's selection of the starting travel date and arrival date. The method can further include receiving a selection of a day in the graph, and selecting a corresponding day in the calendar as either the starting travel date or the arrival date. The graph can include more months than a number of months shown in the calendar. The calendar can include a tab for designating fixed or flexible schedule, and wherein the method further includes determining days to price based on a received selection of fixed or flexible. Determining a value of the feature for a respective day can include determining a value of the feature for each day in a window of time defined by the proposed trip length less the predetermined number of days and the proposed trip length plus the predetermined number of days, and determining the value of the feature can include determining a lowest value of the feature in the window. Determining a lowest value of the feature can include determining a lowest value of the feature and determining a value of the feature that reflects a best value based on a number of predetermined criteria and presenting both the lowest value of the feature and best value of the feature for a given day. The predetermined criteria can be objective and set by a service doing the determining a lowest value of the feature. The predetermined criteria can be objective and/or subjective and selected by the user. The method can further include presenting a control for selecting a filter criteria for use in selecting a trip comprising the lowest value of the feature, and wherein, upon receipt of the user input indicating the filter criteria, updating a value of the feature for a given day with a trip comprising the lowest value of the feature that conforms with indicated filter.

In general, another innovative aspect of the subject matter described in this specification can be implemented in computer program products that include a computer program product tangibly embodied in a computer-readable storage device and comprising instructions. The instructions, when executed by one or more processors, cause the processor to: receive an indication of travel preferences of a user for a trip including a starting location, a starting travel date, a destination and an arrival date, wherein a length of time from the starting travel date to the arrival date constitutes a proposed trip length; present, in a calendar, at least two months including at least a month associated with the starting travel date; determine, for one or more days from the starting travel date, a value of a feature associated with a value of originating travel on a respective day for the trip, including determining a lowest value of the feature of a ticket to travel on a trip starting on the respective day that lasts a projected number of days, wherein the projected number of days is the proposed trip length plus or minus a predetermined delta number of days; present, in a first user interface, the lowest value of the feature for each day of the one or more days in the calendar; and present, in the first user interface, the lowest value of the feature for each day in a graph, wherein the graph includes one axis that represents value of the feature and one axis that represents days.

In general, another innovative aspect of the subject matter described in this specification can be implemented in systems, including a system comprising: a user interface engine for receiving user input from a user interface and providing pricing information for presentation within the user interface; an engine for determining the feature information for a plurality of days based on a combination of traveler preferences including starting point, start date, arrival date, destination; and a service provider interface engine for requesting service provider feature information from plural service providers.

Particular implementations may realize none, one or more of the following advantages. Users can be provided with a visual representation of feature information that makes it easier to identify and select economical pricing to travel. Presented values of the feature can automatically include values of the feature associated with user-specified ranges (e.g., specific dates) and further include prices that are outside of the specified ranges. The user can be presented with price information for travel dates, for example, that include dates and/or travel parameters that the user may not have considered and that may be significantly lower in value of the feature.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing price information for an itinerary.

FIG. 2A shows an example system for presenting price information associated with an itinerary.

FIG. 2B provides a detailed example of a user interface that presents price information in a calendar and in a graph.

FIG. 2C provides a detailed example of the user interface that is updated after selection of a particular starting travel date.

FIG. 3 is a flowchart of an example process for providing price information.

FIG. 4 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and mechanisms for providing price information. For example, the price information can include prices associated with airline travel or for other purposes. In some implementations, a pricing system can receive an indication of travel preferences from a user for a planned trip that includes a starting location, a preferred starting travel date, a destination, and an arrival date. The system can compute a length of time from the starting travel date to the arrival date as a proposed trip length. A calendar can be presented to the user, and the calendar can include at least two months, including at least a month associated with the starting travel date. Initial pricing information be determined for commencing travel with one or more carriers on various dates to the destination where the trip length is varied (e.g., one or more days from a respective starting travel date). For a given calendar date (start date), a plurality of trips are evaluated, each starting on the calendar date and ending on a date that is within a threshold window of the arrival date provided by the traveler. Each determined price can be associated with a cost of originating travel on a respective day for the trip. Determining the price information for a specific day can include determining a lowest price of a ticket to travel on a trip starting on a respective day that terminates in the window. For example, the window can be the proposed trip length plus or minus a predetermined number of days. The lowest price for each day of the one or more days in the calendar can presented in a user interface, e.g., in a calendar that includes at least two months. The lowest price for each day can also be presented in a graph, for example, that includes a vertical axis representing price and a horizontal axis representing days.

In some implementations, after a user selects a specific starting travel day after presentation of the initial pricing information, second pricing information can be computed and presented in the calendar and graph. The second pricing information can represent, for a given day, the lowest travel cost for a trip that ends on the respective day. Implementations of the subject matter may include other features for assisting the user in selecting optimum travel accommodations as discussed in further detail below.

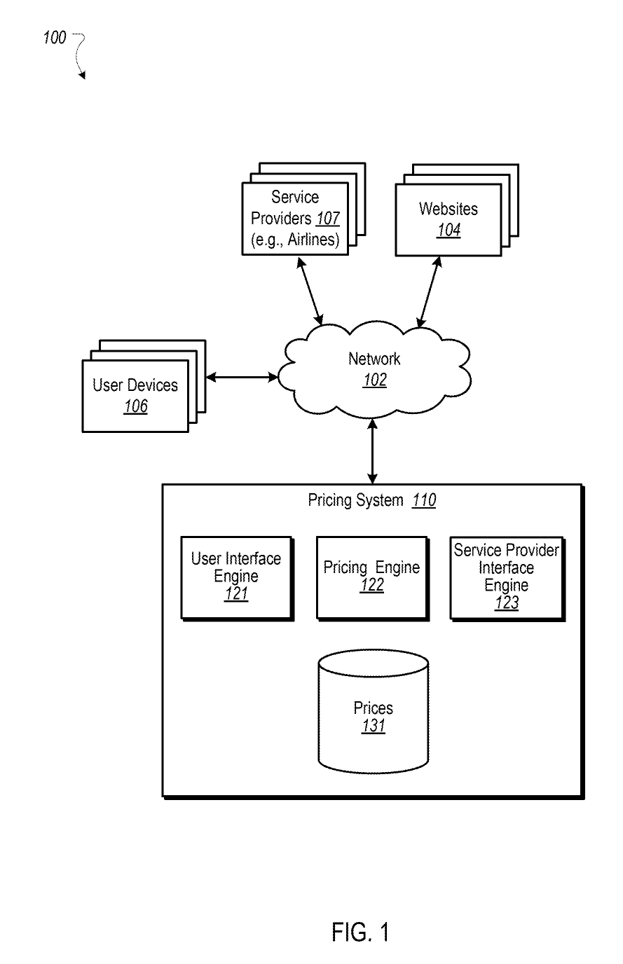

FIG. 1 is a block diagram of an example environment 100 for providing price information for a trip, e.g., related to air travel. The example environment 100 includes a pricing system 110 for determining prices and for presenting information associated with the prices to a user. The example environment 100 includes a network 102, such as a local area network (LAN), a wide area network (WAN), the Internet, or a combination thereof. The network 102 connects websites 104, user devices 106, service providers 107 (e.g., airline carriers), and the pricing system 110. The example environment 100 may include many thousands of websites 104, user devices 106, and service providers 107.

The environment 100 can include plural data stores, which can be stored locally by the pricing system 110, stored somewhere else and accessible using the network 102, generated as needed from various data sources, or some combination of these. A data store of prices 131, for example, can include prices (e.g., airline prices) associated with the service providers 107 (e.g., airline carriers).

The pricing system 110 can be resident on a user's user device 106, available for use on a website 104 and accessible over the network, or some combination thereof. The pricing system 110 can include plural engines, some or all of which may be combined or separate, and may be co-located or distributed (e.g., connected over the network 102). A user interface engine 121, for example, can receive user input from a user interface and provide pricing information for presentation within the user interface.

A pricing engine 122, for example, can determine a price for a plurality of days based on a combination of traveler preference (e.g., start date, arrival date, destination), and defined windows. A price can be associated with a cost of originating travel on a respective day for the trip. Determining the price can include, for example, determining a lowest price of an airline ticket to travel on a trip starting on the respective day that lasts a projected number of days. The projected number of days, for example, can be the proposed trip length plus or minus a predetermined number of days.

A service provider interface engine 123, for example, can request price information from service providers 107 (e.g., airline carriers). For example, the requests can be for the lowest prices associated with particular days and meeting other selection criteria.

A user device 106 can be an electronic device that is under control of a user and is capable of requesting and receiving information over the network 102. Example user devices 106 include personal computers (PCs), mobile communication devices (e.g., smartphones), tablet computers, televisions with one or more processors embedded therein or coupled thereto, set-top boxes, and other devices that can send and receive data over the network 102. A user device 106 typically includes one or more user applications, such as a web browser, to facilitate the sending and receiving of data over the network 102. The user device 106 can also include a front end application that includes some or all of the pricing system 110.

A user device 106 can be used to access resources such as websites 104. In turn, data from the resources can be provided to the user device 106 for presentation by the user device 106. In some implementations, the websites 104 can include travel- and airline-related websites.

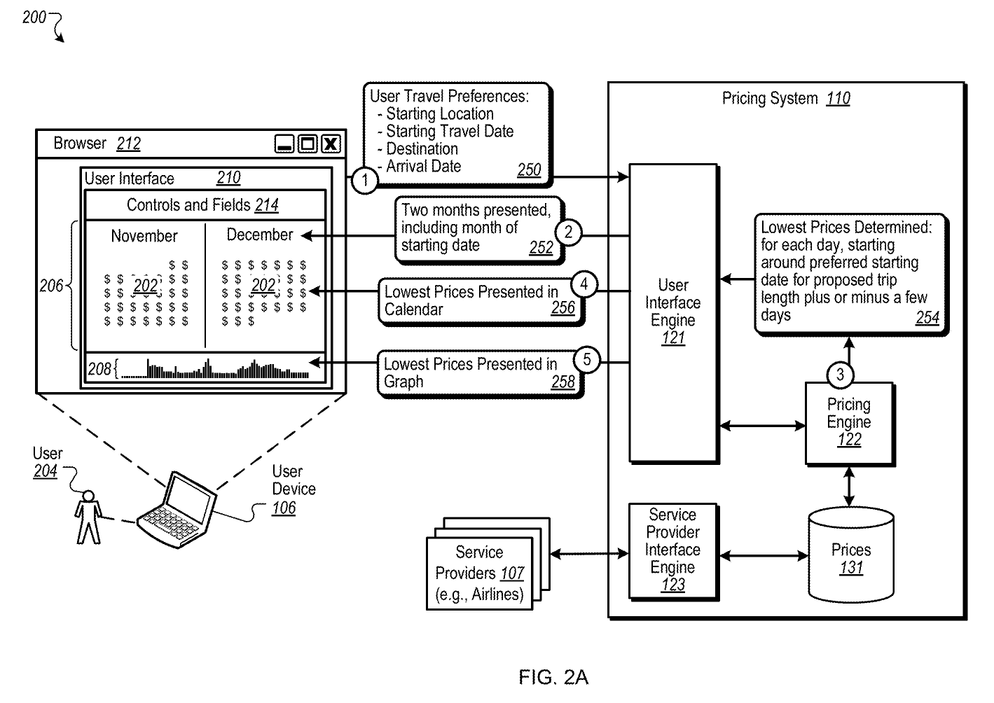

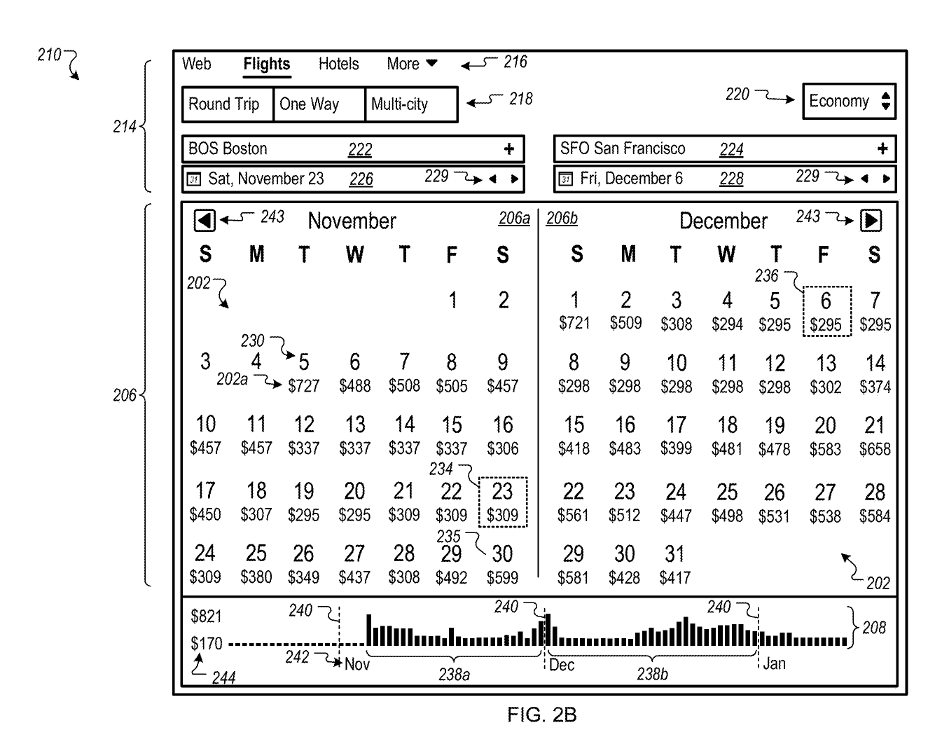

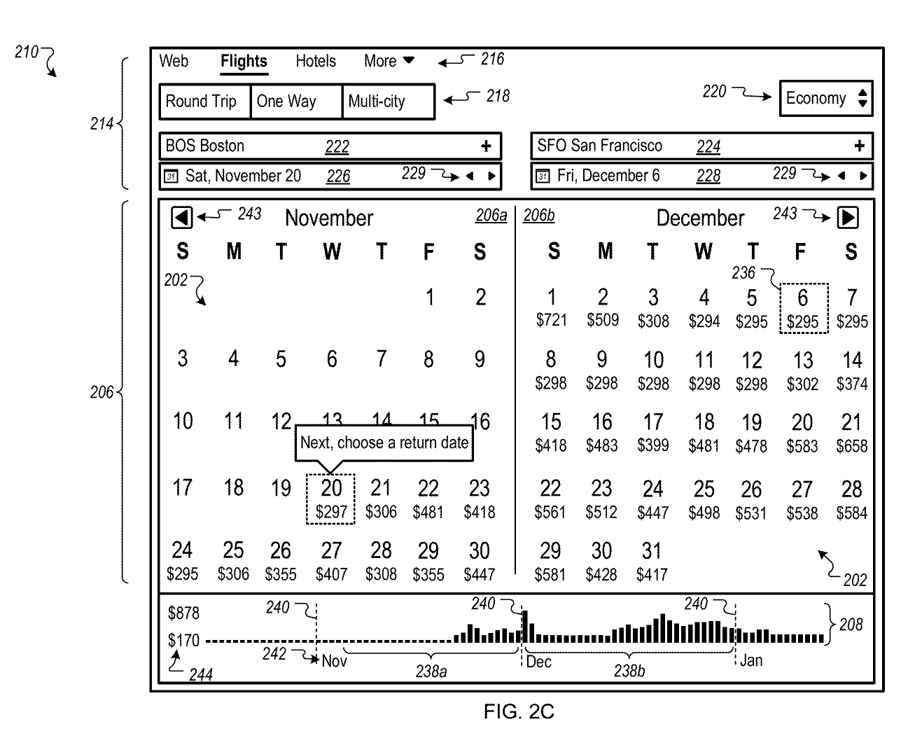

FIG. 2A shows an example system 200 for presenting lowest prices 202 associated with an itinerary. In some implementations, itinerary can include air travel, and the prices can be prices associated with the air travel. For example, the system 200 can present the lowest available daily airfare prices to a user 204 in a calendar 206, and further represent the lowest prices in a graph 208, such as in a user interface 210. The information can be presented, for example, when the user 204 uses an application or visits a web site in order to determine prices for a potential purchase of airline tickets. Other uses of the system 200 can include presenting prices for hotel or other accommodations, automobile rentals, rail, other travel- or business-related or daily priced commodities, or combinations thereof. In some implementations, the user interface 210 can be presented when the user 204 visits a travel-related web page using a browser 212 or when the user 204 executes a travel-related application on a user device 106. Other ways for presenting the user interface 210 are possible. An example sequence of stages for the system 200 is provided below.

FIG. 2B provides a detailed example of the user interface 210 that presents lowest prices 202 in the calendar 206 and in the graph 208. For example, the user interface 210 can be presented after the user selects a destination (e.g., Boston) for a planned airplane trip.

The user interface 210 can include controls and fields 214 for selecting options and specifying information for which the prices 202 are generated. In some implementations, the controls and fields 214 can include high-level browser options 216, e.g., from which the user can select an option for obtaining flight information and making reservations. In some implementations, similar options can exist for hotel accommodations, automobile rentals, or for other purposes. When the controls and fields 214 are related to airline flights, for example, trip type controls 218 can include controls for user options related to a round trip, a one-way trip, a multi-city trip, or other types of trips or airfares. Travel class controls 220 can provide the user 204 with options to select one or more acceptable types of travel class, e.g., business class, coach class, first class, or other classes. A starting point control 222 can be used to enter (or select form a list) a starting point (e.g., Boston) for the proposed airplane trip. A destination control 224 can be used to enter (or select form a list) a destination (e.g., San Francisco) for the proposed airplane trip. Date controls 226 and 228 can be used to designate preferred travel dates, e.g., departure and arrival dates, respectively. In some implementations, dates entered in the date controls 226 and 288 can be changed using date scrolling controls 229. In some implementations, the dates and destination are pre-loaded in the fields 214, such as when a user has been re-directed from another property after having already provided such information. The travel dates provided can be target, or approximate, as the user will be provide with the opportunity to select specific dates as discussed further below, such as when the user 204 selects specific dates based on presented price information.

Based on a combination of user inputs and selections in the controls and fields 214, the system 200 can generate and display price information in the form of the prices 202 in the calendar 206. Each displayed price 202, for example, can be provided adjacent to a calendar date in respective calendar months 206a and 206b. For example, for the November 5 entry in the November calendar month 206a, a day 230 is “5” and a corresponding price 202a is $727. The displayed months (e.g., November and December) can be chosen, for example, based on a date (e.g., November 23) specified by the user 204 in the date control 226. In some implementations, controls 232 can be used to cycle among months, e.g., advancing forward or backward while displaying two months at a time. In some implementations, other ways for displaying and cycling through the months are possible, and a different number of months other than two can be presented. In some implementations, other information, such as best value prices, described below, can be provided in the calendar 206, and also represented in the graph 208, e.g., using different colors or other presentation techniques. Each day in the calendar 206 can display one or more prices. In some implementations, price information provided in the calendar 206 can represent total travel costs, such as including attending fees (e.g., bag fees for airlines, or resort fees for hotels, fuel surcharges for various carriers, or site-specific fees).

In the example shown in FIG. 2B, the user 204 has initially specified November 23 as a start date. This date can be confirmed by the user, but at this point the price information that is generated assumes a measure of flexibility in the user and as such calculates price data for various configurations of travel that are not specifically tied to this date. In the example shown, the user interface 210 has placed a box around an entry 234 (e.g., for November 23) in the calendar 206. The entry 234 can include, for example, the calendar day (e.g., 23), and beneath that is displayed the price 202 (e.g., $309). Similarly, a box surrounds an entry 236 in the calendar 206, the date of which corresponds to the date (e.g., December 5) specified in the date control 226.

The price in the entry 234 can represent the lowest price determined from plural service providers (e.g., airline carriers) for a trip leaving Boston on November 23 and arriving in San Francisco on a day that is in a predetermined window, e.g., a trip having a length of 15 days (e.g., November 23 to December 6), plus or minus a delta (e.g., two days) relative to December 6. Thus, the price of $309 is the lowest price for flights leaving that day for trips of 13-17 days, and following the parameters specified in the controls and fields 214. Referring to the following Saturday 235, e.g., November 30, the cheapest flight leaving that day and having a trip length of 15 plus or minus two days is $599. As will be described in detail with reference to FIG. 2C, user selection of one of the entries in the calendar 206 can result in an updated display that provides updated price information relative to the selected day.

The graph 208 includes graph elements (e.g., bars), each of which can correspond to (and have a height associated with) a price 202 on a given day. In this example, elements 238a correspond one-to-one to days in November, and elements 238b correspond one-to-one to days in December. In some implementations, month separators 240, shown in FIG. 2B with dotted lines, can be used to separate graph 208 entries by month. Month labels 242 can indicate the names of the months for which entries between month separators 240 correspond. In some implementations, low and high price labels 244 (e.g., $170 and $821, respectively) can indicate, by their vertical placement relative to the graph 208, minimum and maximum prices that are contained in the graph. Other values can be chosen for the range labels.

In some implementations, hovering over a bar in the graph 208 can cause the corresponding entry in the calendar 206 to be highlighted, and clicking on a bar in the graph 208 can cause the corresponding entry in the calendar 206 to be selected. The graph 208 can generally contain at least the entries corresponding to all of the displayed entries in the calendar 206. For example, the graph 208 can also display other data (e.g., outside the date range shown in the calendar). In this way, the user 204 can be presented with additional price information not contained in the present view of the calendar 206. Other ways of presenting graph information are possible, including using multiple colors, shading and other ways of differentiating values in the graph. Referring again to FIG. 2A, prices 202 and the presentation of the calendar 206 and the graph 208 can be determined, for example, in the following stages.

At stage 1, for example, the user interface engine 121 can receive an indication of initial travel preferences of the user 204 for a trip (e.g., an airline trip) including a starting location, a starting travel date, a destination, and an arrival date. A length of time from the starting travel date to the arrival date can constitute a proposed trip length. For example, the user interface engine 121 can receive the user travel preferences 250 from the user interface 210. For example, using the user interface 210, the user 204 can specify Boston as the starting location using the starting point control 222, and specify November 23 as the starting travel date in the departure date control 226. The user can also specify San Francisco as the destination using the destination control 224, and specify December 6 as the arrival date in the arrival date control 228. Using these inputs, for example, the pricing engine 223 can calculate a length of time of 15 days, e.g., the number of days from November 23 to December 6. Other ways of specifying travel preferences can be used.

At stage 2, for example, the user interface engine 121 can present at least two months in a calendar, including at least a month associated with the starting travel date. As an example, the user interface engine 121 can identify the months November and December as the months associated with the user's input in the user interface 210. The user interface engine 121 can provide the two months 252 to the user interface 210, e.g., for display in the calendar 206 (e.g., as prices 202).

At stage 3, for example, the pricing engine 122 can determine initial pricing information including a price for one or more days from the starting travel date, where each price is associated with a cost of originating travel on a respective day for the trip. Determining the price can include, for example, determining a lowest price of a ticket to travel on a trip starting on the respective day that lasts a projected number of days, wherein the projected number of days is the proposed trip length plus or minus a predetermined number of days. For example, the pricing engine 122 can determine the prices 254 as described above for prices 202 with respect to FIG. 2B. As an example, each of the prices 202 can be a lowest price for a given day for all trips of a projected number of days (e.g., 13-17) that is determined from the proposed trip length (e.g., 15 days), plus or minus a delta number of days (e.g., two days).

At stage 4, for example, the user interface engine 121 can present the lowest price for each day of the one or more days in the calendar in a first user interface. For example, the user interface engine 121 can provide the lowest prices for the calendar 206, e.g., for populating prices 202 in the calendar 206.

At stage 5, for example, the user interface engine 121 can present the lowest price for each day in a graph in the first user interface. The graph includes one axis that represents price and one axis that represents days. For example, the user interface engine 121 can provide the lowest prices for the graph 208, e.g., for determining the heights of the bars in the graph 208. In this example, the left (y) axis in the graph 208 can be labeled with low and high price labels 244, and the bottom (x axis) of the graph 208 can represent the days in the calendar 206.

FIG. 2C provides a detailed example of the user interface 210 that is updated after selection of a particular starting travel date. For example, if the user 204 selects a particular date (e.g., November 20), the graph 208 can be updated with new price information including the prices 202 shown in FIG. 2C. In another example, the same result can occur if the user 204 selects (e.g., clicks on) the graph element in the graph 208 that corresponds to the November 20 entry in the calendar 206. Other ways at arriving at the updated calendar 206 and prices 202 are possible, including, for example, manual entry of a date or selection of a date from a list.

Changes in the calendar 206, e.g., relative to that shown in FIG. 2B, can include changes to the prices 202. For example, the values of the prices can change, as they now represent the lowest price of returning on the trip on that day, given the selection of the particular starting travel date (e.g., November 20). Also, no prices 202 exist in the calendar 206 for days before November 20. The graph 208 can also be updated, e.g., with graph elements having new heights that represent the corresponding updated prices 202 in the calendar 206. Also, fewer total graph elements can exist, e.g., in elements 238a, as dates before November 20 have been eliminated.

In some implementations, selection of an ending date or some other input on the calendar 206, the graph 208, or elsewhere in the user interface 210 can result in the dismissal of the calendar 206 and the graph 208. For example, the user 204 can be navigated to next steps in planning a trip, e.g., using the dates that have been selected.

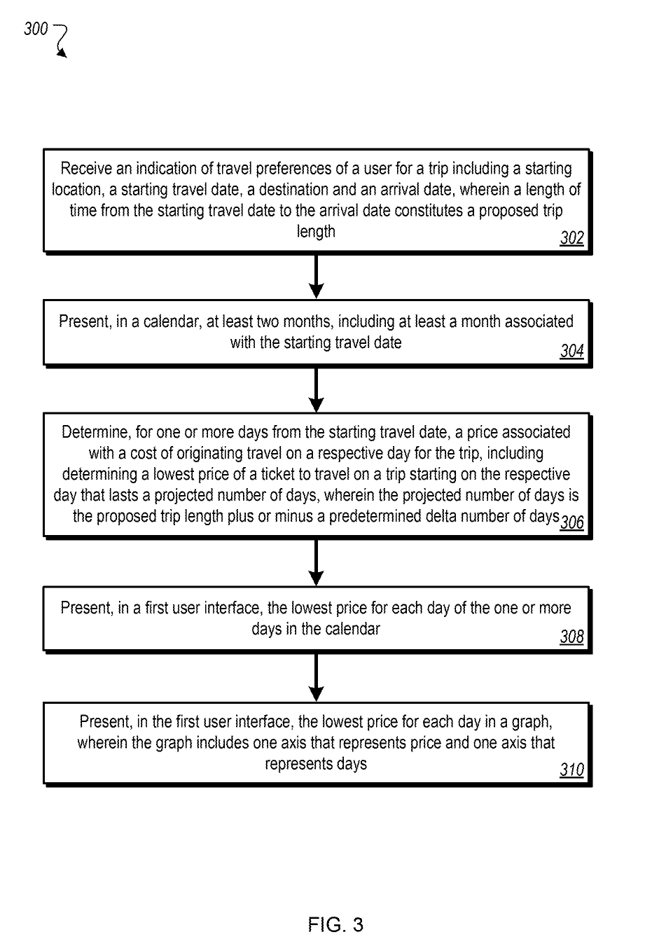

FIG. 3 is a flowchart of an example process 300 for providing price information, e.g., for an air travel trip. In some implementations, the pricing system 110 can perform stages of the process 300 using instructions that are executed by one or more processors. FIGS. 1-2C are used to provide example structures for performing the steps of the process 300.

An indication is received of travel preferences of a user for a trip (e.g., including air travel) including a starting location, a starting travel date, a destination and an arrival date (302). A length of time from the starting travel date to the arrival date can constitute a proposed trip length. As an example, the user interface engine 121 can receive the user travel preferences 250 from the user interface 210. For example, as described above and using controls 222-228 in the user interface 210, the user 204 can specify Boston as the starting location, November 23 as the starting travel date, San Francisco as the destination, and December 6 as the arrival date. The pricing engine 223 can use these inputs, for example, to calculate a length of time of 15 days, e.g., the number of days from the starting travel date (e.g., November 23) to the arrival date (e.g., December 6).

At least two months are presented in a calendar, including at least a month associated with the starting travel date (304). For example, the user interface engine 121 can select November and December for the calendar months 206a and 206b, respectively, in the calendar 206, with the month of November being selected because it includes the starting travel date of November 23.

For one or more days from the starting travel date, a price is determined that is associated with a cost of originating travel on a respective day for the trip (306). Determining the price can include determining a lowest price of a ticket to travel on a trip starting on the respective day and that lasts a projected number of days, wherein the projected number of days is the proposed trip length plus or minus a predetermined number of days. For example, as described above, the pricing engine 122 can determine lowest prices 254 for each of the days presented in the calendar 206. The prices 254 can be determined, for example, as the lowest prices from the prices 131. In some implementations, in order to update available prices 131, the service provider interface engine 123 can request price information from service providers 107 (e.g., airline carriers), the request being a request for lowest carrier prices associated with the days presented in the calendar 206 and associated with the inputs provided by the user 204 using trip type controls 218 and travel class controls 220. Other ways of requesting and/or receiving price information from service providers can be used. In some implementations, prices can be provided by third-party systems that interface with service providers 107 to provide travel information and prices to consumers and/or to plan trips or for other purposes.

In some implementations, the trip can include air travel, and the price can be a price associated with the air travel. For example, the prices 254 determined by the pricing engine can be for an airline trip being planned for the user 204. In some implementations, the system 200 can be used for other purposes, e.g., for hotel accommodations, car rentals, or other trips and/or user needs.

In some implementations, the predetermined number of days can be two (e.g., forming a window of 5 days). For example, the pricing engine 122 can determine prices for various trip lengths of 15 days plus or minus two days, as described above. In some implementations, the delta number of days can be two by default, or a different number can be selected (e.g., 3-5). In some implementations, the number of days selected and used can depend on various factors, e.g., including holiday/peak pricing periods and/or characteristics of the user (e.g., to extend the delta to find cheaper prices more distant from the calculated duration). In some implementations, the user can be presented with an option to specify a different number of days, e.g., when the system 200 determines that a significant price savings opportunity exists. In some implementations, the number of days in the window is unbalanced, including more days after than before a target arrival date.

In some implementations, determining a price for a respective day can include determining a price for each day in a window of time defined by the proposed trip length less the predetermined number of days, and the proposed trip length plus the predetermined number of days, wherein determining the price includes determining a lowest price in the window. For example, given a trip length of 15 days and a number of two days, the pricing engine 122 can calculate, for any given day in the calendar 206, the lowest price for trips leaving that day and having a trip length of between 13 and 17 days.

In some implementations, determining a lowest price can include determining a lowest price and determining a price that reflects a best value (e.g., absolute cheapest price) based on a number of predetermined criteria and presenting both the lowest price and best value price for a given day. For example, the pricing engine 122 can calculate a lowest price 202 for a given day in the calendar 206, and also calculate a best value price, e.g., based on predetermined criteria used by the pricing engine 122 and/or using inputs provided by the user 204. In some implementations, the predetermined criteria can be objective and set by a service (e.g., the pricing engine 122) doing the determining of a lowest price. In some implementations, the predetermined criteria can be objective and/or subjective and selected by the user. For example, the user can specify that travel at night is preferred, travel in the morning is to be avoided, and certain airports are to be avoided as lay-overs. Other criteria are possible.

The lowest price for each day of the one or more days in the calendar is presented in a first user interface (308). For example, the prices 254 determined by the pricing engine 122 can be presented to the user 204 as prices 202 in the calendar 206, as described above.

In some implementations, the calendar can include a tab for designating fixed or flexible schedule, and the method can further include determining days to price based on a received selection of fixed or flexible. For example, the user interface 210 can include additional controls (not shown in FIG. 2B) by which the user 204 can specify a degree by which traveling is to strictly or not so strictly follow a schedule represented by the departure date and/or the arrival date. Example controls can allow the user 204 to specify, for example, that “I must leave after Date X, return by Date Y, or not be traveling on Date Z.

The lowest price for each day is presented in a graph in the first user interface (310). The graph includes one axis that represents price and one axis that represents days. For example, the user interface engine 121 can provide price information and/or instructions for generating the graph 208 in the user interface 210. In some implementations, the graph 208 can include a vertical price axis represented by low and high price labels 244 (e.g., $170 and $821, respectively), and a horizontal axis associated with days and indicated by month labels 242.

In some implementations, the process 300 can further include receiving a selection of a day in the graph, and selecting a corresponding day in the calendar as either the starting travel date or the arrival date. For example, the user interface 210 can allow the user to select, e.g., by clicking, a date in the graph 208 as either the starting travel date or the arrival date. The user 204 may do this, for example, after noticing a relatively short height of the bar representing the day in the graph, e.g., indicating a relatively cheaper price associated with that particular day. In some implementations, by hovering over bars in the graph 208 representing particular days, or by hovering over corresponding days in the calendar 206, the user 204 can be presented with a popup that includes detailed information associated with the day and without changing the displayed prices 202 in either of the calendar 206 or the graph 208. Other ways of interfacing with the graph are possible.

In some implementations, the graph can further include more months than a number of months shown in the calendar. For example, while the calendar 206 may display just two months of information (e.g., November and December), the graph 208 can be extended, as shown in FIG. 2B, to include price information for October and January. By selecting individual graph elements corresponding to these additional months, for example, the user can be presented with the corresponding price information. In some implementations, selecting either October or January, for example, can cause the calendar 206 to be shifted by a month to include that selected month as one of the two months displayed.

In some implementations, the process 300 can further include steps for updating the displayed price information based on a user selection of a specific start date, as described above with reference to FIG. 2C. A selection of a starting travel date can be received (e.g., by the user interface engine 121) in association with the presentation of the first user interface. For example, the user 204 can select November 20 on the calendar 206 by selecting (e.g., clicking on) the corresponding entry in the calendar 206 or on the corresponding bar in the graph 208. Price information (e.g., prices) for the calendar can be updated, including determining a lowest price to complete a trip that starts on the selected starting travel date and ends on a respective day. For example, the pricing engine can calculate new price information, different from the prices 254, and this time based on November 20 as being the specified departure date. Each of the prices for Day N calculated for display in the calendar 206, then, can indicate the lowest airline price for a leaving on November 20 and returning on Day N. Thus, the only dates and prices that appear in the calendar 206 and graph 208 in FIG. 2C are for November 20 and later. The calendar can be updated, including presenting updated price data for each respective day of the one or more days. For example, the user interface engine 121 can present the prices 202, as shown in FIG. 2C.

In some implementations, the graph can also be updated to reflect the updated price information. For example, whenever the calendar 206 is updated with new prices 202, the corresponding elements in the graph 208 can also be updated.

In some implementations, the process 300 can further include receiving a selection of an arrival travel date in association with the presentation of the first user interface without receiving a selection of the starting date. For example, this selection can be made by the user 204 by selecting an arrival date using the arrival date control 228 and leaving the departure date blank using the departure date control 224. The price information can be updated for the calendar 206, including determining a lowest price to complete a trip that ends on the selected arrival date. For example, the trip duration of 15 days plus or minus two days can be used to determine prices, relative to a preferred arrival date of December 6. The calendar 206 can be updated, including presenting updated price data for each respective day of the one or more days. For example, prices 202 presented on that day and days before and after can provide the user with information allowing the user to save money by selecting the same or different travel days. Similarly, the user may have a strict departure date with an open-ended starting date. In this situation, the calendar may be used to present price information that is associated with windows (similar to a fixed starting date), so as to enable a user to select a travel option that is best suited to both price and the fixed departure date input received.

In some implementations, the process 300 (e.g., after receipt of the starting travel date and presentation of the initial price information) can further include receiving a selection of an arrival date, and presenting a selection to the user of a lowest fare for the selected starting date and selected arrival date including presenting the user with a filter to receive preference selections for filtering trips based on one or more trip parameters. Example trip parameters can include number of stops, length of trip, type of airplane, on-time performance (e.g., of the airline), configuration of airplane, service provider (e.g., specific airline), or a rating of the airplane or the service provider. Other trip parameters are possible. In some implementations, users can be provided with controls for identifying and/or ranking which trip parameters are important to them and should be used in the selection of best value prices. In some implementations, the filtering step can be performed before selection of either the starting or arrival dates as desired by the individual user.

In some implementations, the user interface 210 can provide additional information associated with parameters. For example, the user interface 210 provide information that can quantify a parameter setting provided by the user, e.g., with a message in a popup that says, “Note, this setting will cost you $50.” In another example, for parameters associated with selecting a particular airline, for example, the user interface 210 can provide a message that says, “you should try to fly Example Airlines” or receive from the user 204 input that specifies that the user wants to fly Example Airlines, whenever possible. In another example, the user interface 210 can provide a message that says, “Return flights on Sundays are generally more expensive.”

In some implementations, the process 300 can further include surfacing to the user a lower cost alternative that approximates the user's selection of the travel preferences as compared to a price associated with a trip that is based on the user's selection of the starting travel date and arrival date. For example, in addition to presenting prices 202 based on the user's inputs for travel dates and locations, the pricing engine 122 can search for and identify other prices that are excluded from, but lower than, the prices 202, e.g., including an absolute lowest price.

In some implementations, the process 300 can further include presenting a control for selecting filter criteria for use in selecting a lowest cost trip. Upon receipt of the user input indicating the filter criteria, a price for a given day can be updated with a lowest priced trip that conforms with the indicated filter. For example, after initial display of prices 202 in the calendar 206, the user 204 can use controls to make selections associated with a number of stops, trip length, airplane type, on-time performance, airplane configuration, service provider, or a rating of airplane or the service provider. The pricing engine 122, for example, can use the filtering information from the user's selections in order to update the prices 202.

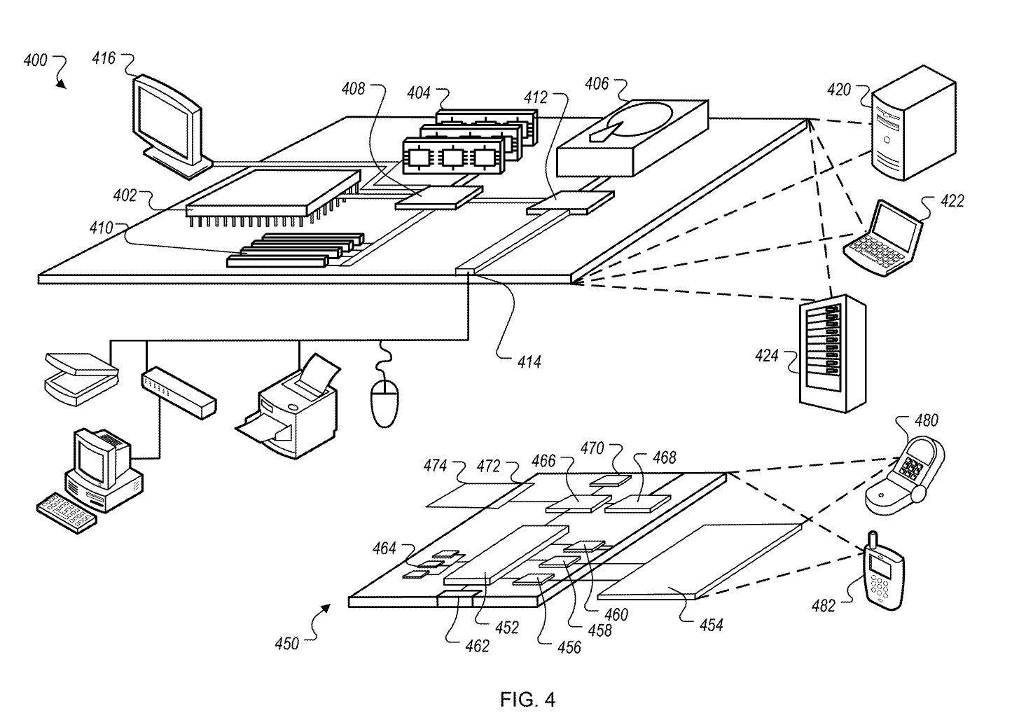

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processors embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method to render graphical user interfaces to display values of features for trips comprising a projected number of days and based on indications of user travel preferences for the trips, comprising:
receiving, using one or more computing devices, an indication of travel preferences for a trip including a starting location, a starting travel date, a destination and a return date, wherein a length of time from the starting travel date to the return date constitutes a proposed trip length;
providing, using the one or more computing devices, instructions to the user computing device causing the user computing device to render a graphical user interface, the graphical user interface comprising a calendar, at least one month including at least a month associated with the starting travel date;
determining, using the one or more computing devices, for one or more days from the starting travel date, a value of a feature associated with a cost of originating travel on a respective day for the trip, including determining a lowest value of the feature of a ticket to travel on a trip starting on the respective day that lasts a projected number of days, wherein the projected number of days is the proposed trip length plus or minus a predetermined number of days; and
providing, using the one or more computing devices, instructions to the user computing device causing the user computing device to render, via the graphical user interface, an indication, in the calendar, of the lowest value of the feature for each respective day of the one or more days and a graph comprising an indication of the value of the feature for each respective day, wherein the graph comprises one axis that represents value of the feature and one axis that represents days.

2. The method of claim 1, wherein the trip includes air travel and the value of the feature comprises a price associated with the air travel.

3. The method of claim 1, wherein the predetermined number of days is two.

4. The method of claim 1, wherein presenting the calendar includes presenting two months including a month of and a month following the arrival date.

5. The method of claim 1, further comprising:
receiving, using the one or more computing devices, a selection of a starting travel date in association with the presentation of the graphical user interface;
updating, using the one or more computing devices, feature data for the calendar including determining a lowest value of the feature to complete a trip that starts on the selected starting travel date and ends on a respective day; and
providing, using the one or more computing devices, instructions to the user computing device causing the user computing device to render, via the graphical user interface, updated feature data for each respective day of the one or more days.

6. The method of claim 5, further comprising providing, using the one or more computing devices, instructions to the user computing device causing the user computing device to render, via the graphical user interface, an updated graph to reflect the updated feature data.

7. The method of claim 1 further comprising:
receiving, using the one or more computing devices, a selection of an arrival travel date in association with the presentation of the graphical user interface without receiving a selection of the starting date;
updating, using the one or more computing devices, feature data for the calendar including determining a lowest value of the feature to complete a trip that ends on the selected arrival date; and
providing, using the one or more computing devices, instructions to the user computing device causing the user computing device to render, via the graphical user interface updated feature data in the calendar for each respective day of the one or more days.

8. The method of claim 1, further comprising:
receiving, using the one or more computing devices, a selection of an arrival date via the graphical user interface; and
providing, using the one or more computing devices, instructions to the user computing device causing the user computing device to render, via the graphical user interface, an indication of a selection to the user of a lowest value of the feature for the selected starting date and selected arrival date including presenting the user with a filter to receive preference selections for filtering trips based on one or more trip parameters.

9. The method of claim 8, wherein the trip parameters are selected from the group comprising number of stops, length of trip, type of airplane, on-time performance, configuration of airplane, service provider or rating of airplane or service provider.

10. The method of claim 9, further comprising surfacing to the user a lower value alternative that approximates the user's selection of the travel preferences as compared to a value of the feature associated with a trip that is based on the user's selection of the starting travel date and arrival date.

11. The method of claim 1, further comprising:
receiving, using the one or more computing device, a selection of a day in the graph via the graphical user interface; and
selecting, using the one or more computing devices, a corresponding day in the calendar as either the starting travel date or the arrival date.

12. The method of claim 1, wherein the graph includes more months than a number of months shown in the calendar.

13. The method of claim 1, wherein the calendar includes a tab for designating fixed or flexible schedule, and wherein the method further includes determining days to determine a value of the feature based on a received selection of fixed or flexible.

14. The method of claim 1, wherein determining a value of the feature for a respective day includes determining a value of the feature for each day in a window of time defined by the proposed trip length less the predetermined number of days and the proposed trip length plus the predetermined number of days, and wherein determining the value of the feature includes determining a lowest value of the feature in the window.

15. The method of claim 14, wherein determining a lowest value of the feature includes determining a lowest value of the feature and determining a value of the feature that reflects a best value based on a number of predetermined criteria and presenting both the lowest value of the feature and best value of the feature for a given day.

16. The method of claim 15, wherein the predetermined criteria are objective and set by a service conducting the determining of a lowest value of the feature.

17. The method of claim 15, wherein the predetermined criteria are objective and/or subjective and selected by a user.

18. The method of claim 1, further comprising:
providing, using the one or more computing devices, instructions to the user computing device causing the user computing device to render, via the graphical user interface, a control for selecting a filter criteria for use in selecting a trip comprising a lowest value of the feature, and wherein, upon receipt of the user input indicating the filter criteria, updating a value of the feature for a given day with a trip comprising a lowest value of the feature that conforms with indicated filter.

19. A computer program product, comprising:
a non-transitory computer-readable storage device having computer-executable program instructions embodied thereon that when executed by a computer cause the computer to render graphical user interfaces to display values of features for trips comprising a projected number of days and based on indications of user travel preferences for the trips, the computer-executable program instructions comprising:
computer-executable program instructions to receive an indication of travel preferences for a trip including a starting location, a starting travel date, a destination and a return date, wherein a length of time from the starting travel date to the return date constitutes a proposed trip length;
computer-executable program instructions to provide instructions to the user computing device causing the user computing device to render a graphical user interface, the graphical user interface comprising a calendar, at least one month including at least a month associated with the starting travel date;
computer-executable program instructions to determine, for one or more days from the starting travel date, a value of a feature associated with a cost of originating travel on a respective day for the trip, including determining a lowest value of the feature of a ticket to travel on a trip starting on the respective day that lasts a projected number of days, wherein the projected number of days is the proposed trip length plus or minus a predetermined number of days; and
computer-executable program instructions to provide instructions to the user computing device causing the user computing device to render, via the graphical user interface, an indication, in the calendar, of the lowest value of the feature for each respective day of the one or more days and a graph comprising an indication of the value of the feature for each respective day, wherein the graph comprises one axis that represents value of the feature and one axis that represents days.

20. A system to render graphical user interfaces to display values of features for trips comprising a projected number of days and based on indications of user travel preferences for the trips, comprising:
a storage resource; and
a processor communicatively coupled to the storage resource, wherein the processor executes application code instructions that are stored in the storage resource to cause the processor to:
receive an indication of travel preferences for a trip including a starting location, a starting travel date, a destination and a return date, wherein a length of time from the starting travel date to the return date constitutes a proposed trip length;
provide instructions to the user computing device causing the user computing device to render a graphical user interface, the graphical user interface comprising a calendar, at least one month including at least a month associated with the starting travel date;
determine, for one or more days from the starting travel date, a value of a feature associated with a cost of originating travel on a respective day for the trip, including determining a lowest value of the feature of a ticket to travel on a trip starting on the respective day that lasts a projected number of days, wherein the projected number of days is the proposed trip length plus or minus a predetermined number of days; and
provide instructions to the user computing device causing the user computing device to render, via the graphical user interface, an indication, in the calendar, of the lowest value of the feature for each respective day of the one or more days and a graph comprising an indication of the value of the feature for each respective day, wherein the graph comprises one axis that represents value of the feature and one axis that represents days.
